(19) United States
(12) Patent Application Publication
(10) Pub. No.: US 2004/0065798 A1
(43) Pub. Date: Apr. 8, 2004

(54) Coupling system for suspended article and adapters therefor

(76) Inventor: Nelson Douglas Pitlor, Twinsburg, OH (US)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 10/680,947

(22) Filed: Oct. 7, 2003

Related U.S. Application Data
(63) Continuation-in-part of application No. 10/007,509, filed on Dec. 5, 2001.
Application No. 10/007,509 is a continuation-in-part of application No. 09/730,920, filed on Dec. 6, 2000, now Pat. No. 6,644,617.

(51) Int. Cl. B42F 13/00

(52) U.S. Cl. 248/342

(57) ABSTRACT

A system for releasably coupling an article to a support structure includes a plurality of adapters having a desired geometry that cooperates with the coupling and the article to (a) securely but releasably support the article, (b) provide an aesthetically pleasing appearance, and (c) structurally support the article. Each of the adapters varies from at least one other adapter in at least one aspect, such as size, shape, dimension, etc., for use with different articles to be mounted thereon. Specifically, for a light fixture, for example, a fixed base can be mounted to a ceiling over an electrical “splice box.” A mount is releasably couplable to the base using an installation and removal tool, and the adapter provides an interface between the mount and the light fixture. The adapter has a sidewall with one or more openings or passages therethrough to provide access for an installation and removal tool to engage the mount. The system can include a plurality of such adapters, each having different features to accommodate different articles.

This is a continuation-in-part of application Ser. No. 10/007,509, filed Dec. 5, 2001, which is a continuation-in-part of application Ser. No. 09/730,920, filed Dec. 6, 2000, both of which hereby are incorporated herein by reference.

### FIELD OF THE INVENTION

The present invention generally relates to a releasable coupling for an article, such as a light or a smoke detector, for example, and more particularly, to a system including such a coupling and an interface with the article.

### BACKGROUND OF THE INVENTION

In the past, a relatively heavy article generally would not be removably suspended with a decouplable coupling because of the relatively high force (e.g., greater than 1 lb (about 4.45 N)) required to disengage the article. Such force would have to be applied while standing on a step-ladder or other means that permitted a person to reach the article. The higher the force required, the greater the risk of falling off the step-ladder.

More recently, a new assembly has allowed a relatively small force, easily applied, sometimes even with one hand, to angulate the centerline of a suspended subassembly relative to a fixed base sufficiently to allow the suspended subassembly to disengage the fixed base. One such new assembly is represented by the fixture coupling system disclosed in U.S. patent application Ser. No. 10/007,509 filed Dec. 5, 2001 and published on Jun. 27, 2002 under Publication No. US 2002/0079412A1, the entire disclosure of which is hereby incorporated herein by reference.

Such a coupling system can be advantageous when dealing with a device that is suspended or intended to be suspended from a ceiling, wall or other overhead location. A tool that can couple and uncouple the suspended subassembly from the base can be mounted at the end of a pole to reach the suspended subassembly when it is mounted at an elevated position, such as the aforementioned wall or ceiling. This system makes it easier to locate and manually to secure a device on a high, out-of-reach ceiling or other overhead location without using something to stand on, such as a ladder or other support means that raises the person to the device for mounting or dismounting.

### SUMMARY OF THE INVENTION

The present invention provides a mounting system with an adapter having a geometry that provides a secure mounting arrangement between a releasably secured mount and an article mounted thereto, while also providing an improved aesthetic appearance of the system as a whole. The adapter may act as a cover that conceals the mounting components therein.

The present invention provides a mounting system for an article that includes a base securable to a support, a mount to which an article can be mounted that is releasably couplable or mountable to the base, and an adapter associated with the mount that has a geometric configuration that provides a secure interface between the mount and an article mountable to the mount.

The adapter can include one or more passages therethrough that communicate between the mount and the article to provide access through the adapter to the mount. The illustrated adapter has a substantially flat central mounting surface that separates the mount and an article. The adapter has one or more side walls extending from the periphery of the central mounting surface that enclose the sides of the mount. The side walls have one or more openings therein for receipt of a tool for coupling and uncoupling the mount and the base. The adapter also includes one or more guide passages that extend from the one or more openings in the side walls to guide a tool to the mount. The adapter also can include one or more ribs that strengthen the other side of the adapter.

The present invention also provides a plurality of adapters from which the desired adapter is selected, each adapter having a different geometric characteristic. The mount can have a generally cylindrical shape and the adapter can have a substantially circular rib to register the adapter on the mount.

Of course, the system can also include an article mounted to the mount.

The present invention also provides a method of releasably magnetically coupling subassemblies of an assembly including a base and a mount comprises securing the base to a ceiling of a room to provide a secured subassembly; securing an article to be supported to the mount using an adapter interposed between the article and the mount, the adapter being selected from a plurality of adapters interchangeably connectable to the mount; interposing a magnet and a ferrous plate between the base and the mount while supporting the mount on an installation and removal tool on the end of a rod or pole, the mount including either the magnets or the ferrous plate; registering the ferrous plate to the magnets to engage them; and removing the installation and removal tool. The method also can include selecting the adapter from a plurality of adapters that have a generic mounting arrangement for connecting to the mount and a variety of shapes to provide different effects with an article to be supported.

The foregoing and other features of the invention are hereinafter fully described and particularly pointed out in the claims, the following description and annexed drawings setting forth in detail a certain illustrative embodiment of the invention, this embodiment being indicative, however, of but one of the various ways in which the principles of the invention may be employed.

### BRIEF DESCRIPTION OF DRAWINGS

FIG. 1 is an exploded isometric view of a remotely attachable and separable coupling system of the invention employing a dual retention mechanism.

FIG. 2 is an exploded section view of the system of FIG. 1.

FIG. 3 is a bottom view of the base of the system of FIG. 1.

FIG. 4 is a side elevation view of a retention member for the system of FIG. 1.

FIG. 5 is a top view of a cover of the system of FIG. 1.

FIG. 6 is a top view of an alternate cover of the system of FIG. 1.

FIG. 7 is a top view of another alternate cover of the system of FIG. 1.

### DETAILED DESCRIPTION

The present invention provides a system for releasably coupling an article to a support structure that includes one or more adapters having a desired geometry that cooperates with the coupling and the article to (a) securely but releasably support the article, (b) provide an aesthetically pleasing appearance, and (c) structurally support the article. The adapter also provides access for engaging and uncoupling releasable mounting means. The adapters may vary from at least one other adapter in at least one aspect, such as size, shape, dimension, etc., for use with different articles to be mounted thereon. For a light fixture, for example, a fixed base can be mounted to a ceiling over an electrical “splice box.” A mount is releasably couplable to the base using an installation and removal tool, and the adapter provides an interface between the mount and the light fixture. The adapter has a sidewall with one or more openings or passages therethrough to provide access for the installation and removal tool to engage the mount. The system can include a plurality of such adapters, each having different features to accommodate different articles.

The mount typically provides a generally planar base, or a dish- or cup-shaped member having a generally planar floor with a peripheral wall having one or more openings for engaging the installation and removal tool.

The ability to attach an article to and to remove an article from the ceiling, or from some other location, e.g., an “out of the way” or “hard to reach” location such as high up on a wall or pole, etc., using a tool to decouple a coupling provides an effective solution to an age-old problem. In the illustrated system, the retention mechanism that retains the mount and base together can be hidden from normal view when the system is assembled. Thus, the complete system has an aesthetically pleasing structure.

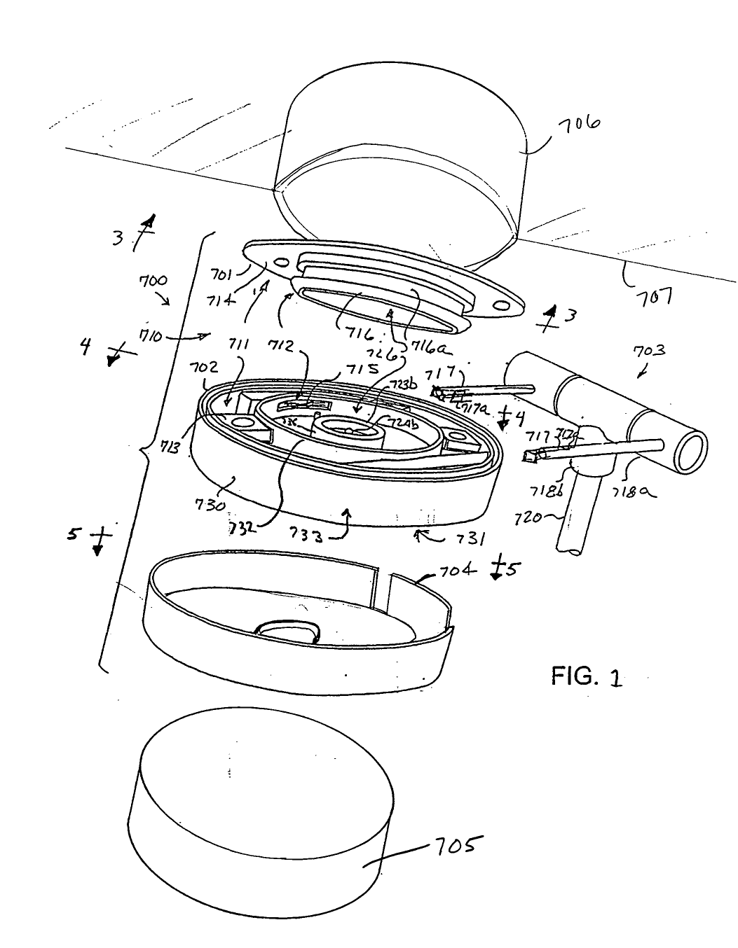

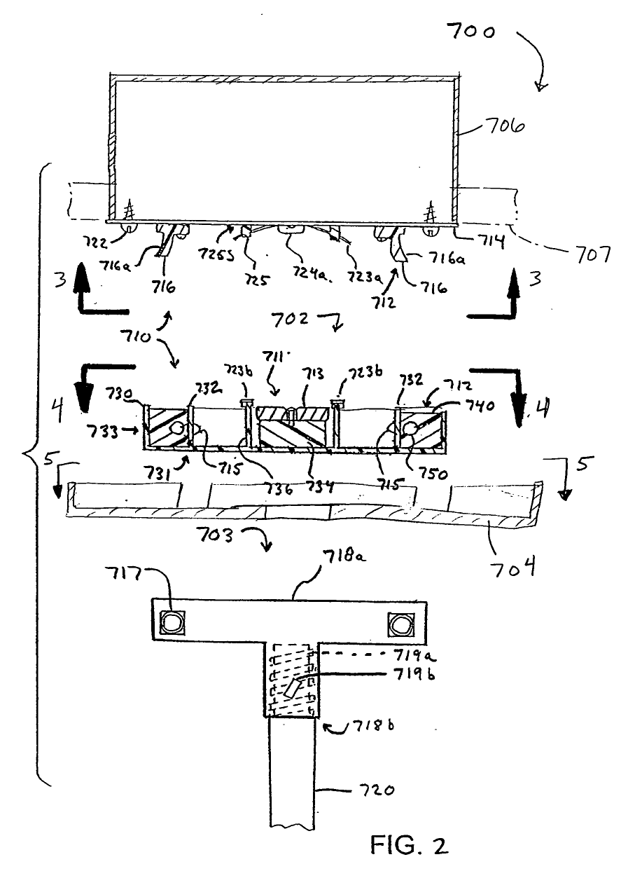

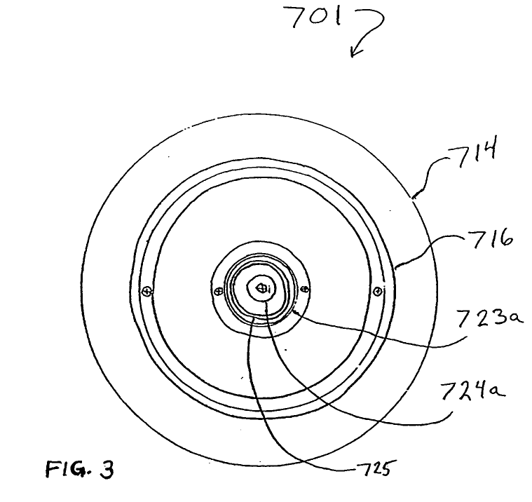

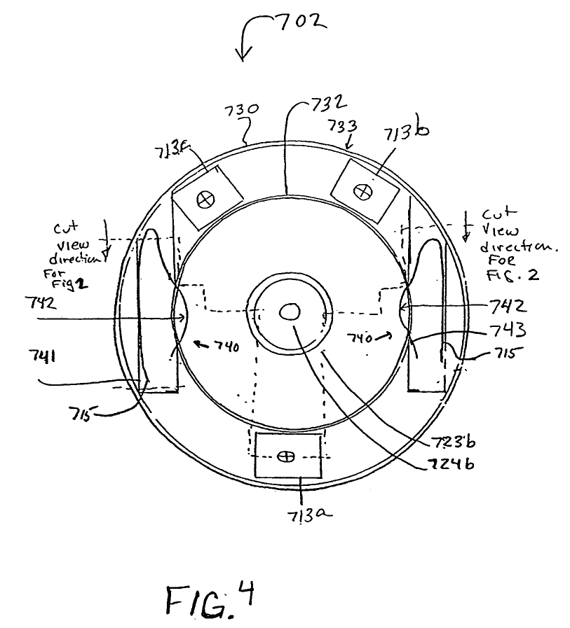

An exemplary remotely attachable and separable coupling system 700 is shown in FIGS. 1-4 and includes both the mentioned “hidden” feature and a dual retention mechanism. The system 700 includes a base 701 and a suspended subassembly, which includes a mount 702 and an adapter 704 for an article 705 to be mounted, and an installation and removal tool 703. The base 701 is intended to be secured to a fixed structure or to some other device, such as an electrical splice box 706 in a ceiling 707, and the mount 702 mates to the base 701.

Removal and installation of the mount 702 to and from the base 701 is accomplished through the use of the installation and removal tool 703. The installation and removal tool 703 may be used for remote installations of the system 700, allowing the user to remain safely on ground level while installing or removing the mount 702 relative to the remotely located or otherwise difficult to reach base 701. An article 705, such as a fixture or other device, may be coupled to the mount 702; exemplary articles include a smoke detector or other detector, a light fixture (or part thereof), a sign, a signaling device, a viewing device such as a camera, a display, etc. Various techniques, e.g., screws, clips, adhesive, etc., may be used to couple the article 705 to the mount 702.

To register the couplable components, the suspended subassembly, which includes the mount, the adapter and an article to be mounted, is held on the installation and removal tool and is advanced to the secured subassembly or base to couple them together. The tool and the end of the rod are used to support and balance the suspended subassembly as it is positioned to engage the base. After the mount is coupled to the base, arms of the tool are removed from the mount to lock the mount to the base. The suspended subassembly may be serviced by inserting the end of the arms of the tool into the mount, and while the tool is engaged with the mount, exerting sufficient force to decouple the mount from the base, supporting the suspended subassembly on the end of the tool and lowering the suspended subassembly to allow it to be removed. The components of an exemplary system will now be described in more detail.

The dual retention mechanism 710 for holding together or coupling the base 701 and the mount 702 includes a magnetic coupling system or device 711 and a selectively operable mechanical retainer 712. The magnetic coupling system includes at least one, and the illustrated system 711 includes more than one magnet 713 and another part 714 to which the magnets may hold with a magnetic retention force. Such other part 714 may be a ferrous plate, another metal or other material to which a magnet may tend to hold, or even another magnet. In the illustrated embodiment, three magnets 713a, b, c are shown distributed about the mount 702 for engaging the opposing part 714 in the base 701.

The selectively operable mechanical retainer 712 provides a secure mechanical coupling between the base 701 and the mount 702 when coupled together. Such mechanical coupling ordinarily would retain the base 701 and mount 702 coupled together, such as in case the magnetic coupling system 711 were to release unexpectedly, for example. The selectively operable mechanical retainer 712 includes a movable grabber member 715 and a retention member 716. The grabber member 715 may be operated by the installation and removal tool 703.

The installation and removal tool 703 is used to couple or to decouple the mount 702 with respect to the base 701. The tool includes decoupling arms 717 that cause the grabber member 715 to retract from a retaining or locking relation with the retention member 716 as the decoupling arms are inserted into the mount 702. These arms 717 act as a key that “unlocks” the grabber member 715. The tool 703 has a base 718a with a socket 718b that accepts an elongated member, such as a pole 720. A pole can increase the reach of the tool to permit access to normally out of reach locations for coupling or decoupling the mount 702 with respect to the base 701 of the system 700.

The base 701 forms the inner half of the system 700 and is secured to a structure, such as a wall, a pole or the illustrated ceiling 707. In many uses the structure may be relatively fixed, e.g., a wall, or movable, e.g., a pole. The base 701 includes several subcomponents, one of which is the base plate 714. The base plate 714 is the primary instrument for attaching the base 701 to a fixed object and provides strength and rigidity to the base 701. Fasteners secure the base plate to the ceiling 707. The base plate 714 is made from a rigid material, such as steel, but it may be made out of any suitable material that provides the strength and rigidity to support the mount 702 and any device 705 attached to the mount. In the illustrated embodiment, the base plate 714 is made of a ferrous or other material to which the magnets 713 may be held by magnetic force. An alternative coupling system can include one or more Velcro® fasteners in place of the magnets and base plate. The base plate 714 attaches the remaining subcomponents of the base 701. These subcomponents include the retention member 716, an electrically conductive ring 723a, a fixed electric terminal 724a, and an electrical insulation ring 725.

The illustrated system 700 uses a dual retention mechanism 710 that includes two different coupling systems to secure the mount 702 to the base 701. The first, the magnetic coupling system or device 711, was briefly described above. The second coupling system is a mechanical coupling system 712, also referred to as the selectively operable mechanical retainer, which is distributed between the base 701 and the mount 702. The base 701 coupling component includes retention member 716, which is attached to the base plate 714. The retention member 716 can be constructed in several different forms, although a circular ring has an advantage over other designs. For example, a circular ring retention member can be aligned with its respective member in the mount 702 regardless of the orientation of the mount 702 relative to the base 701. The retention member 716 has a groove, recess, chase, or other geometry 716a along its outer edge to accept the grabber member 715, such as a clip or similar device, from the mount 702, such that after the mount 702 and the base 701 are mated together, the clip fits inside the groove or other geometry of the retention member 716 and prevents the two units from separating. Separation requires that the clip 715 be mechanically moved from a position in which it cooperates with the retention member 716 to hold the base and mount together to a position releasing the mount from the base. This can be accomplished remotely, if necessary, using the installation and removal tool mounted on a pole.

Electrical connections 726 may be provided between the base 701 and the mount 702. For example, electrical connections on the base 701 may provide electrical power from the base 701 to the mount 702 to power an article that is attached to or is part of the mount 702 such as a light fixture type device 705. The electrical connections also may be used as a signal connection, in which case it will transmit data to and from a device attached to the mount 702 relative to some remote location. For example, the device 705 attached to the mount 702 may be a smoke detector and the signal connection may be to a remote computer, the computer having the responsibility of monitoring the status of one or more devices within a building. If the smoke detector detects a problem (e.g., low battery charge, high temperature, or smoke), the smoke detector will transmit the data over the signal connection to the central computer and the computer may act accordingly. The electrical connections also may be used to monitor the status of the system 700 or the device 705. For example, instead of sending a digital transmission to a central computer, the signal may be a simple contact closure to an alarm panel, or some other indication device. Such electrical coupling apparatus may require that the mount 702 and the base 701 be aligned in a specific orientation relative to each other in order to make the proper connections.

In the illustrated embodiment, the electrical connections 726 are formed by electrically conductive circular rings 723a/723b and centrally located fixed electrical terminals 724a/724b associated with the base 701 and mount 702, respectively. The conductive circular rings 723 (refers to both 723a, 723b) and fixed terminals 724 (refers to both 724a, 724b) provide a quick and safe mechanism for connecting and disconnecting the electrical signals or power between the base 701 and the mount 702 without the requirement of physically removing a connection (e.g., manually disconnecting a wire from a terminal). In fact, the base and the mount are couplable and decouplable without manually touching either one. “Without manually touching” means that there is no contact of the subassemblies with a person's hand during installation or removal of the mount. Furthermore, such electrical connection arrangement is not dependent on the orientation of the base 701 relative to the mount 702.

Although the orientation of the base 701 mated to the mount 702 is irrelevant with respect to the electrical connection, orientation of the adapter 704 can be important to ensure access for the installation and removal tool 703 to the mount. In addition to the adapter 705 shown in FIG. 1, three exemplary adapters 804, 904, 1004 are shown in FIGS. 5-7, respectively. The adapter 804 shown in FIG. 5 is similar to the adapter 704 shown in FIG. 1. Each adapter 804, 904, 1004 has a circular dish shape with a peripheral wall 806, 906, 1006 extending from one side of a generally circular surface 808, 908, 1008. The peripheral wall includes a pair of openings 810, 910, 1010 therein for receipt of the arms 717 (FIG. 1) of the installation and removal tool 703 (FIG. 1) to extend therethrough to the mount 702 (FIG. 1). Each adapter 804, 904, 1004 also includes a central opening 812, 912, 1012 in the circular surface to provide access to the electrical connectors 726 in the mount 702 (FIG. 1), as well as one or more additional openings 813, 913, 1013 for locating the adapter relative to the mount or for fastening the adapter to the mount.

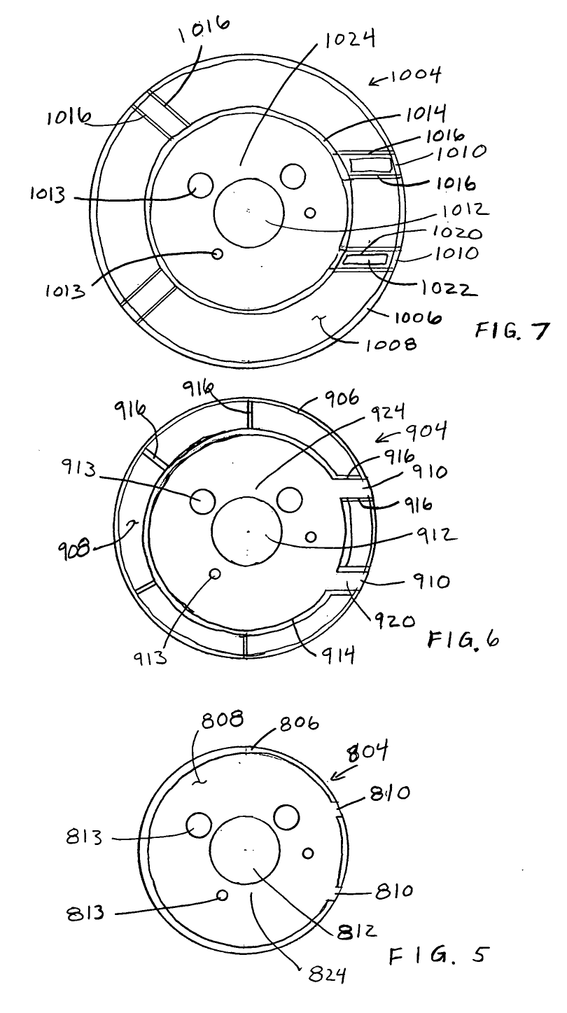

The adapters 904, 1004 shown in FIGS. 6 and 7, for example, also include an interior wall 914, 1014 that helps to register the adapter to the mount. This interior wall is sized to receive the mount therein and typically is sized to closely receive the mount therein. These adapters 904, 1004 also have one or more ribs 916, 1016 for structurally stiffening or strengthening the adapter, and these ribs can also be arranged to define channels 920, 1020 that guide the arms of the installation and removal tool therethrough to engage the mount. The adapter 1004 shown in FIG. 7 also has ramp members 1022 in the channels 1020 that help guide the arms of the installation and removal tool 703 (FIG. 1) in a height direction perpendicular to the view shown in FIG. 7.

The adapter 804, 904, 1004 may be made of a rigid plastic or other material or composite. The adapter could be metal and, if necessary, have suitable electrical insulation to protect against short circuits in electrical connections 726 (FIG. 1). A face portion 824, 924, 1024 of the adapter 804, 904, 1004 is flat on both sides to provide a mounting platform for an article 705, such as a light fixture or a smoke detector, on an outside surface and for the mount 702 (FIG. 1) on an inside surface.

The outside surface of the adapter 804, 904, 1004, outside of the face portion 824, 924, 1024, can have any appropriate shape or texture to complement the article 705 attached to the face portion. For example, to help the adapter blend into a ceiling that has a textured surface, the surface of the adapter also can be provided with a similar texture. As another example, consider a light fixture mounted on a corner. In that situation the adapter can have a shape that conforms to the corner. The adapter may have any other arbitrary and fanciful shape to complement the article 705 mounted thereto. In fact, it is important to note that the system provided by the present invention comprises a plurality of adapters that are interchangeably attachable to the mount 702 to provide different aesthetic or structural advantages in conjunction with an article to be suspended from the adapters, or to provide different aesthetic or structural advantages for suspending an article selected from a plurality of different articles available for suspension.

In use, the illustrated adapter 704, 804, 904, 1004 can completely cover the mount, acting as a cover to conceal both the mount 702 and the base 701. Referring to FIGS. 1-7, the mount 702 has a substantially cylindrical disk shape with one or more openings in a peripheral wall for engagement with the installation and removal tool 703. As noted above, a dual retention mechanism 710 holds the mount 702 to the base 701. In the illustrated embodiment, a plurality of magnets 24 in the mount 702 engage a metal plate 714 in the base 701 to hold the mount to the base. The strength of the magnets 24 is chosen to correspond with the weight of the articles to be suspended. As will readily be apparent, the greater the weight to be suspended, the stronger the magnetic force required and the greater the force required to disengage a suspended mount that is magnetically coupled with the base. Magnet mounts or standoffs 734 in the mount provide an elevated mounting surface for the magnets 713, such that the magnets are approximately flush with the top surface of the outer wall 733 of the mount and can mate with and secure to the base plate 714.

In addition to the magnetic coupling system 711, the illustrated system also includes a mechanical coupling system 712, and together they form the dual retention mechanism 710. The magnetic coupling system 711 and the mechanical coupling system 712 operate in tandem and ensure that if one coupling system fails, the other coupling system will maintain the mount 702 attached to the base 701. The mechanical coupling system 712 may take on several forms, such as a retractable clip system as shown in FIGS. 1-4, or a touch latch or a slam latch, for example.

A retractable clip system 740 type of mechanical coupling system 712 is used in the illustrated system 700 to secure the mount 702 to the base 701. In the retractable clip system 740, the clip 715 is integral to the mount 702 and interfaces with the retention member 716 of the base 701. The clip 715 resides within a clip holder 741. The clip 715 may be metallic, plastic or any suitable material that provides strength and flexibility. The clip 715 has a male portion 742 that is supported from a resilient spring like support 743 in the clip holder 741; the male portion 742 is effectively spring loaded within the clip holder 741 and tends to extend out of the clip holder 741 at a clip slot. The clip male portion 742 engages the retention member 716 of the base 701 and can be retracted by the insertion of the arms 717 of the installation and removal tool 703.

The clip holder 741 includes a tool guide slot 750 that accepts the decoupling arms 717 of the installation and removal tool 703. The tool guide slot 750 is shown in the drawings as being circular in shape, but it may have any geometric configuration, e.g., to cooperate with the arms 717 and the clip. The shape of the tool guide slot 750 may be keyed to the shape of the arms 717, e.g., square, circular, hexagonal, or an unusual cross-section shape, so that only arms 717 of the prescribed cross-sectional shape would be able to fit into the tool guide slot or to release the mechanical coupling system 712. This keying can provide a measure of security to avoid removal of the mount 702 from the base 701 by an unauthorized individual.

The tool guide slot 750 also provides a path along the surface of the clip 715 such that as the arms 717 are inserted, the arms push the clip 715 inside the clip holder 741, thus disengaging the male portion 742 of the clip from the retention member 716. After the mechanical coupling is disengaged, a lateral force may be applied to the mount 702 using the installation and removal tool 703 to break the magnetic bond and thus to remove the mount 702 from the base 701. It follows that the reverse procedure may be implemented to install the mount 702 to the base 701.

The installation and removal tool 703 includes a base 718a, which has an attachment slot 718b or socket that allows an elongated member such as pole 720 to be inserted into the base. Insertion and use of a pole 720 allows the installation and removal tool 703 to be extended into areas not normally accessible to install or remove the mount 702 relative to a base 701, e.g., without the assistance of some other height altering device, such as a step ladder. The decoupling arms 717 extend out from the base 718a and are of sufficient length to retract the retaining clips 715 as the arms 717 are inserted through the openings or passages in the adapter and into the guide slots 750 urging the male portion 742 of the respective clips into the clip holder 741. Also, the decoupling arms 717, as well as the other portions of the installation and removal tool 703, provide the required strength and stability to support, to manipulate, or to position the mount 702, including any attached device 705, and the necessary force required to disengage the magnetic coupling system.

The fixed subassembly or “base” may have any arbitrary configuration, providing a dish-shaped base, for example, as shown in the illustrated embodiment; the suspended subassembly also may have any arbitrary configuration. Each suspended subassembly is interchangeably couplable to the base; for example, a configuration of the suspended subassembly may include a box-shaped mount, the mount having an overall rectangular shape and planar floor. Though the shapes of the base and mount are not necessarily interrelated and may be arbitrary as long as the shapes allow the coupling means to be engaged and disengaged when desired, it is convenient to use a generally circular base and mount for ease of assembly and accurate registration of coupling means.

In using the system 700 of the present invention, the base 701 is assumed to be fixed to a rigid member, such as a wall or a pole. One would place the suspended subassembly, including the mount 702 and the adapter 704, onto the installation and removal tool 703 by inserting the decoupling arms 717 of the tool 703 into the tool guide slots 750. Fully inserting the decoupling arms 717 into the mount 702 locks the mount 702 to the tool 703. Using the pole, the suspended subassemby is positioned against the base 701. The magnetic coupling system 711 engages the mount and provides a holding force to keep the mount 702 attached to the base 701. This provides an unobstructed path in the tool guide slot 750 for the decoupling arms 717 to pass through, thus allowing the decoupling arms 717 to be retracted from the mount 702. After the decoupling arms 717 are removed from the mount, the clip 740 extends out of the clip slot and engages the retention member 716 of the base, thus locking the base 701 and mount 702 together.

To remove the suspended subassembly from the base 701, the tool 703 is moved to engage the mount 701. The decoupling arms 717 are inserted into the tool guide slots 750, thus urging the clip 740 back into the clip holder 741 and unlocking the mount 702 from the base 701. The magnetic coupling system 711 continues to hold the base 701 and mount 702 together. Using the pole 720, force is applied to the mount 702 to break the magnetic bond between the base 701 and the mount 702. As the mount 702 is separated from the base 701, notches 717a in the decoupling arms engage locking means to lock the mount to the tool 703. The mount may now be safely lowered to ground level.

A method of releasably magnetically coupling subassemblies of an assembly that includes a base and a mount comprises securing the base to a ceiling of a room to provide a secured subassembly; securing an article to be supported to the mount using an adapter interposed between the article and the mount, the adapter being selected from a plurality of adapters interchangeably connectable to the mount; interposing a magnet and a ferrous plate between the base and the mount while supporting the mount on an installation and removal tool on the end of a rod or pole, the mount including either the magnets or the ferrous plate; registering the ferrous plate to the magnets to engage them; and removing the installation and removal tool. The method also can include selecting the adapter from a plurality of adapters that have a generic mounting arrangement for connecting to the mount and a variety of shapes to provide different effects with an article to be supported.

Although the invention has been shown and described with respect to certain illustrated embodiments, equivalent alterations and modifications will occur to others skilled in the art upon reading and understanding the specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function (i.e., that is functionally equivalent), even though not structurally equivalent to the disclosed structure which performs the function in the herein illustrated embodiments of the invention. In addition, while a particular feature of the invention may have been described above with respect to only one of several illustrated embodiments, such a feature may be combined with one or more other features of the other embodiment, as maybe desired and advantageous for any given or particular application.

What is claimed is:

1. A mounting system for an article, comprising:
a base securable to a support,
a mount to which an article can be mounted that is releasably couplable to the base, and
an adapter associated with the mount that has a geometric configuration that provides a secure interface between the mount and an article mountable to the mount.

2. A mounting system as set forth in claim 1, wherein the adapter includes one or more passages therethrough that communicate between the mount and an article mountable thereto.

3. A mounting system as set forth in claim 1, wherein the adapter includes means for locating the adapter on the mount.

4. A mounting system as set forth in claim 1, wherein the adapter includes one or more ribs that strengthen the underside of the adapter.

5. A mounting system as set forth in claim 1, wherein the adapter has a substantially flat central mounting surface that separates the mount and an article mountable thereto.

6. A mounting system as set forth in claim 5, wherein the flat surface is bounded by a peripheral wall that cooperates with the flat surface to enclose the sides of the mount, the peripheral wall including one or more openings therein for an installation and removal tool to engage the mount for coupling and uncoupling the mount and the base.

7. A mounting system as set forth in claim 1, wherein the adapter includes one or more guide passages that extend from the one or more openings in the peripheral wall to guide an installation and removal tool into engagement with the mount.

8. A mounting system as set forth in claim 1, wherein the mount includes means for positioning the positioning the adapter on the mount.

9. A mounting system as set forth in claim 1, wherein the mount has a generally cylindrical shape and the adapter has a substantially circular rib to register the adapter to the mount.

10. A mounting system as set forth in claim 1, further comprising a plurality of adapters from which the adapter is selected, each adapter having a different geometric characteristic.

11. A mounting system as set forth in claim 1, wherein each adapter has a generally cylindrical shape and each adapter has a different diameter and a uniform size rib to register each adapter to the mount.

12. A mounting system as set forth in claim 1, further comprising an article mountable to the mount through the adapter.

13. A method of releasably coupling subassemblies of an assembly that includes a base and a mount, comprises:
securing the base to a ceiling of a room to provide a secured subassembly;
securing an article to be supported to the mount using an adapter interposed between the article and the mount, the adapter being selected from a plurality of adapters interchangeably connectable to the mount;
interposing a magnet and a ferrous plate between the base and the mount while supporting the mount, the adapter and the article to be suspended on an installation and removal tool on the end of a rod or pole, the mount including either the magnets or the ferrous plate;
registering the ferrous plate to the magnets to engage them; and
removing the installation and removal tool.

14. A method as set forth in claim 13, further comprising selecting the adapter from a plurality of adapters that have a generic mounting arrangement for connecting to the mount and a variety of shapes to provide different effects with an article to be supported.
